(19) United States
(12) Patent Application Publication
(10) Pub. No.: US 2024/0247352 A1
(43) Pub. Date: Jul. 25, 2024

(54) STAINLESS STEEL ALLOYS, TURBOCHARGER COMPONENTS FORMED FROM THE STAINLESS STEEL ALLOYS, AND METHODS FOR MANUFACTURING THE SAME

(71) Applicant: Garrett Transportation I Inc., Torrance, CA (US)

(72) Inventors: Pavan Chintalapati, Bangalore (IN); Ragupathy Kannusamy, Bangalore (IN); Prashanth Chimangala Seetharamrao, Bangalore (IN); Arthur Rene Fischer, Thaon-Les-Vosges (FR)

(73) Assignee: Garrett Transportation I Inc., Torrance, CA (US)

(21) Appl. No.: 18/182,025

(22) Filed: Mar. 10, 2023

(30) Foreign Application Priority Data
Jan. 23, 2023 (IN) 202311004508

(51) Int. Cl. C22C 38/48; C21D 9/00; C22C 38/00; C22C 38/02; C22C 38/04; F02C 6/12

(52) U.S. Cl. CPC C22C 38/48; C21D 9/0068; C22C 38/001; C22C 38/02; C22C 38/04; F02C 6/12; C21D 2211/001; F05D 2220/40

(57) ABSTRACT

Disclosed is an austenitic stainless steel alloy that includes or consists of, by weight, about 23.0% to about 25.0% chromium, about 8.5% to about 10.0% nickel, about 0.5% to about 2.0% manganese, about 0.8% to about 1.0% niobium, about 0.5% to about 1.5% silicon, about 0.35% to about 0.45% carbon, about 0.2% to about 0.28% nitrogen, a balance of iron, and other inevitable/unavoidable impurities that are present in trace amounts. The elements zirconium and sulfur are excluded from the alloy beyond impurity levels. Turbocharger turbine housings made of the stainless steel alloy, and methods of making the same, are also disclosed. The stainless steel alloy is suitable for use in turbocharger turbine applications for temperatures up to about 1,020° C.

### CROSS-REFERENCE TO RELATED APPLICATIONS

This application is related to and claims all available benefit of Indian Provisional Patent Application IPA: 202311004508 filed Jan. 23, 2023, the entire contents of which are herein incorporated by reference.

### TECHNICAL FIELD

The present disclosure generally relates to stainless steel alloys. More particularly, the present disclosure relates to stainless steel alloys used for casting applications, for example turbine and turbocharger housings, exhaust manifolds, and combustion chambers, which exhibit oxidation resistance at elevated temperatures.

### BACKGROUND

During operation, automotive or aircraft turbocharger components are subjected to elevated operating temperatures. These components must be able to contain a turbine wheel generating very high rotational speeds. Exhaust gas from the automotive or aircraft engine initially contacts the turbocharger in metal sections, such as the gas inlet area of the turbocharger, at elevated temperatures. As high-speed performance improves through exhaust temperature increase, there have been attempts to gradually raise the exhaust temperature of the engine. Due to these high temperatures, the thermal load on the parts such as the exhaust manifold and the turbine housing becomes very great.

Various problems have been encountered by these increased exhaust gas temperatures contacting metal sections of the turbocharger. For example, one problem caused by the exhaust temperature rise is the problem of corrosion or oxidation. At temperatures above about 800° C., for example, and depending on the particular alloy employed, oxygen may begin to attack the metallic elements of the alloy, causing them to oxidize or corrode and thus lose their beneficial physical and material properties. Over repeated cycles of operation, corrosion or oxidation can eventually cause a part to fail entirely.

In order to overcome the challenges associated with higher operating temperatures, prior art alloys used in turbocharger applications have included stainless steel alloys of higher chromium and nickel content, such as commercially available high chromium and/or nickel stainless steel. As used herein, the term operating temperature refers to the maximum temperature of exhaust gas (barring the occasional higher transient temperatures) designed to be experienced by the turbine housing and blade components of the turbocharger. These higher chromium and nickel stainless steels are primarily austenitic with a stable austenite phase that exists well above the operating temperature, as well as minimal to no delta ferrite phase, which promotes corrosion/oxidation. Stainless steel alloys of the 1.48XX series, such as stainless steel 1.4848, are well-known in the art. Having a specification for chromium between 23% and 27% and a specification for nickel between 19% and 22% (all percentages by weight), they are exemplary prior art materials for turbine housing applications until 1,020° C. While meeting the high temperature property requirements for turbocharger housings, stainless steel 1.4848 is quite expensive because of its high chromium and nickel content. As the turbocharger housing is generally the most expensive component of the turbocharger, the overall cost of the machine is greatly affected by the choice in material employed for this component.

Alternatively, K273 with lower chromium and nickel content can be used for housing temperatures up to 1,020° ° C. However, due to a higher carbon content, K273 poses manufacturing concerns in terms of machinability. Also, laboratory oxidation tests indicated lower oxidation resistance of K273 in comparison with other stainless steels recommended for such high temperature applications. TABLE 1, set forth below, provides the specifications for stainless steels 1.4848 and K273, in percentages by weight:

TABLE 1
Composition of K273 and 1.4848 Stainless Steels.

| | K273 | | 1.4848 | |
|---|---|---|---|---|
| Elements | Min (%) | Max (%) | Min (%) | Max (%) |
| Carbon | 0.75 | 0.9 | 0.3 | 0.5 |
| Silicon | 0.3 | 1 | 1 | 2.5 |
| Chromium | 18 | 21 | 23 | 27 |
| Nickel | 4.5 | 5.5 | 19 | 22 |
| Molybdenum | 0.8 | 1.2 | 0 | 0.5 |
| Manganese | 4.5 | 5.5 | 0 | 2 |
| Tungsten | 0.8 | 1.2 | — | — |
| Niobium | 0.65 | 0.8 | 0 | 1.6 |
| Phosphorus | 0 | 0.02 | 0 | 0.04 |
| Sulphur | 0 | 0.02 | 0 | 0.04 |
| Nitrogen | 0.2 | 0.4 | — | — |

| | | |
|---|---|---|
| Iron | Balance | Balance |

Further, some lower chromium and nickel alloys used for housing temperatures up to 1,020° ° C. have been investigated, however such alloys have often been accompanied by various manufacturing issues, for example associated with the casting process. For example, components formed from such lower chromium and nickel alloys may have porosity issues caused from outgassing of nitrogen during the casting process if the tapping temperature are as high as 1,650° ° C. to 1,700° C. and solidification temperatures are 1,100° ° C. to 1,200° C.

Thus, materials that are less expensive, and that have less manufacturing issues and better oxidation resistance, will be a suitable alternative to the available options. These materials should have a stable austenite phase that exists above the operating temperature, as well as minimal to no delta ferrite phase. Accordingly, there is a need for stainless steel alloys useful in turbocharger applications that are able to withstand the higher operating temperatures produced by modern engines, but that minimize the expensive nickel content. Furthermore, other desirable features and characteristics of the subject matter disclosed herein will become apparent from the subsequent detailed description and the appended claims, taken in conjunction with the accompanying drawings and this background.

### BRIEF SUMMARY

Stainless steel alloys, turbocharger turbine components, and methods of manufacturing turbocharger turbine components are provided.

In an embodiment, an austenitic stainless steel alloy, includes or consists of, by weight, about 23.0% to about 25.0% chromium, about 8.5% to about 10.0% nickel, about 0.5% to about 2.0% manganese, about 0.8% to about 1.0% niobium, about 0.5% to about 1.5% silicon, about 0.35% to about 0.45% carbon, about 0.2% to about 0.28% nitrogen, and a balance of iron, and other inevitable/unavoidable impurities that are present in trace amounts. Zirconium and sulfur are excluded from the alloy beyond impurity levels.

In some embodiments, the austenitic stainless steel alloy includes about 23.5% to about 24.5% chromium.

In some embodiments, the austenitic stainless steel alloy includes about 8.8% to about 9.7% nickel.

In some embodiments, the austenitic stainless steel alloy includes about 0.8% to about 1.7% manganese.

In some embodiments, the austenitic stainless steel alloy includes about 0.8% to about 1.2% silicon.

In some embodiments, the austenitic stainless steel alloy includes about 0.37% to about 0.43% carbon.

In some embodiments, the austenitic stainless steel alloy includes about 0.22% to about 0.26% nitrogen.

In some embodiments, the austenitic stainless steel alloy includes, if present, zirconium in an amount of about 0.02% or less and sulfur in an amount of about 0.04% or less.

According to an alternative embodiment, a turbocharger turbine component includes an austenitic stainless steel alloy. The austenitic stainless steel alloy includes or consists of, by weight about 23.0% to about 25.0% chromium, about 8.5% to about 10.0% nickel, about 0.5% to about 2.0% manganese, about 0.8% to about 1.0% niobium, about 0.5% to about 1.5% silicon, about 0.35% to about 0.45% carbon, about 0.2% to about 0.28% nitrogen, and a balance of iron, and other inevitable/unavoidable impurities that are present in trace amounts. Zirconium and sulfur are excluded from the alloy beyond impurity levels.

In some embodiments, the turbocharger turbine component includes the austenitic stainless steel alloy that includes about 23.5% to about 24.5% chromium.

In some embodiments, the turbocharger turbine component includes the austenitic stainless steel alloy that includes about 8.8% to about 9.7% nickel.

In some embodiments, the turbocharger turbine component includes the austenitic stainless steel alloy that includes about 0.8% to about 1.7% manganese.

In some embodiments, the turbocharger turbine component includes the austenitic stainless steel alloy that includes about 0.8% to about 1.2% silicon.

In some embodiments, the turbocharger turbine component includes the austenitic stainless steel alloy that includes about 0.37% to about 0.43% carbon.

In some embodiments, the turbocharger turbine component includes the austenitic stainless steel alloy that includes about 0.22% to about 0.26% nitrogen.

In some embodiments, the turbocharger turbine component includes a turbocharger turbine housing.

In some embodiments, a vehicle includes a turbocharger turbine component that includes an austenitic stainless steel alloy. The austenitic stainless steel alloy includes, by weight, about 23.0% to about 25.0% chromium, about 8.5% to about 10.0% nickel, about 0.5% to about 2.0% manganese, about 0.8% to about 1.0% niobium, about 0.5% to about 1.5% silicon, about 0.35% to about 0.45% carbon, about 0.2% to about 0.28% nitrogen, and a balance of iron, and other inevitable/unavoidable impurities that are present in trace amounts. Zirconium and sulfur are excluded from the alloy beyond impurity levels.

According to an alternative embodiment, a method of making a turbocharger turbine component is provided. The method includes forming the turbocharger turbine component using an austenitic stainless steel alloy. The austenitic stainless steel alloy includes, by weight, about 23.0% to about 25.0% chromium, about 8.5% to about 10.0% nickel, about 0.5% to about 2.0% manganese, about 0.8% to about 1.0% niobium, about 0.5% to about 1.5% silicon, about 0.35% to about 0.45% carbon, about 0.2% to about 0.28% nitrogen, and a balance of iron, and other inevitable/unavoidable impurities that are present in trace amounts. Zirconium and sulfur are excluded from the alloy beyond impurity levels.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

The accompanying drawings, which are incorporated into and constitute a part of this specification, illustrate implementations of the disclosure and together with the description, serve to explain the principles of the disclosure.

FIG. 1 is a system view of an embodiment of a turbocharger for a turbocharged internal combustion engine in accordance with the present disclosure.

FIG. 2 is a simulated phase diagram of an alloy in accordance with the present disclosure showing the phase constituencies (including austenite and delta ferrite) of the alloy over a temperature from 500° C. to 1,500° ° C.

FIG. 3 is a simulated diagram of nitrogen solubility limits as a function of temperature of an alloy in accordance with the present disclosure.

FIG. 4 is a simulated diagram of nitrogen solubility limits as a function of temperature of an alloy in which the amounts of Cr and Si were altered to achieve increased equilibrium nitrogen solubility in accordance with the present disclosure.

FIG. 5 is a simulated diagram of nitrogen solubility limits as a function of temperature of an alloy having a composition for comparison to the alloy presented in FIG. 4.

FIG. 6 is a graphical representation of nitrogen solubility limits as a function of the amounts of Cr and Mn in an alloy in accordance with the present disclosure.

### DETAILED DESCRIPTION

As required, detailed embodiments of the present disclosure are disclosed herein; however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

Unless specifically stated from context, as used herein, the term “about” is understood as within a range of normal tolerance in the art, for example within 2 standard deviations of the mean. “About” can be understood as within 10%, 5%, 1%, 0.5%, 0.1%, 0.05%, or 0.01% of the stated value. “About” can alternatively be understood as implying the exact value stated. Unless otherwise clear from the context, the numerical values provided herein are modified by the term “about.”

The present disclosure generally relates to austenitic stainless steel alloys suitable for use in various turbocharger turbine and exhaust applications. Exemplary turbocharger turbine components in accordance with the present disclosure include turbine housing components and turbine exhaust components, which are subject to operating temperatures up to about 1,020° C. in some applications. The turbocharger turbine housing, usually a cast stainless steel or cast iron, is often the most expensive component of the turbocharger. Reduction in cost of the housing will have a direct effect on the cost of the turbocharger. In order to withstand the high operating temperatures commonly produced by exhaust gasses impinging on the turbine housing, turbine housing materials are usually alloyed with elements such as chromium and nickel in addition to other carbide forming elements, resulting in increased cost. Reducing the content and/or eliminating these expensive alloying elements will have a direct effect on the cost of the turbine housing.

Typical embodiments of the present disclosure reside in a vehicle, such as a land-, air-, or water-operating vehicle, equipped with a powered internal combustion engine (“ICE”) and a turbocharger. The turbocharger is equipped with a unique combination of features that may, in various embodiments, provide efficiency benefits by relatively limiting the amount of (and kinetic energy of) secondary flow in the turbine and/or compressor, as compared to a comparable unimproved system.

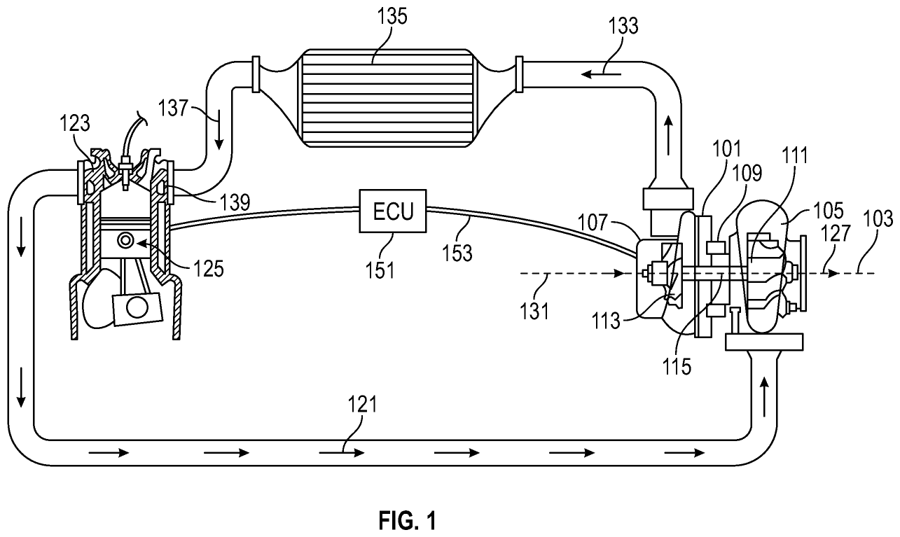

With reference to FIG. 1, an exemplary embodiment of a turbocharger 101 having a radial turbine and a radial compressor includes a turbocharger housing and a rotor configured to rotate within the turbocharger housing around an axis of rotor rotation 103 during turbocharger operation on thrust bearings and two sets of journal bearings (one for each respective rotor wheel), or alternatively, other similarly supportive bearings. The turbocharger housing includes a turbine housing 105, a compressor housing 107, and a bearing housing 109 (i.e., a center housing that contains the bearings) that connects the turbine housing to the compressor housing. The rotor includes a radial turbine wheel 111 located substantially within the turbine housing 105, a radial compressor wheel 113 located substantially within the compressor housing 107, and a shaft 115 extending along the axis of rotor rotation 103, through the bearing housing 109, to connect the turbine wheel 111 to the compressor wheel 113.

The turbine housing 105 and turbine wheel 111 form a turbine configured to circumferentially receive a high-pressure and high-temperature exhaust gas stream 121 from an engine, e.g., from an exhaust manifold 123 of an internal combustion engine 125. The turbine wheel 111 (and thus the rotor) is driven in rotation around the axis of rotor rotation 103 by the high-pressure and high-temperature exhaust gas stream, which becomes a lower-pressure and lower-temperature exhaust gas stream 127 and is axially released into an exhaust system (not shown).

The compressor housing 107 and compressor wheel 113 form a compressor stage. The compressor wheel, being driven in rotation by the exhaust-gas driven turbine wheel 111, is configured to compress axially received input air (e.g., ambient air 131, or already-pressurized air from a previous-stage in a multi-stage compressor) into a pressurized air stream 133 that is ejected circumferentially from the compressor. Due to the compression process, the pressurized air stream is characterized by an increased temperature over that of the input air.

Optionally, the pressurized air stream may be channeled through a convectively cooled charge air cooler 135 configured to dissipate heat from the pressurized air stream, increasing its density. The resulting cooled and pressurized output air stream 137 is channeled into an intake manifold 139 on the internal combustion engine, or alternatively, into a subsequent-stage, in-series compressor. The operation of the system is controlled by an ECU 151 (engine control unit) that connects to the remainder of the system via communication connections 153.

Embodiments of the present disclosure are directed to improvements over the currently available stainless steel alloys for use in turbochargers having operating temperatures up to about 1,020° C. In particular, embodiments of the present disclosure are directed to austenitic stainless steel alloys that have a nickel content that is less than stainless steel 1.4848 for cost considerations, and improved formability and/or manufacturability including castability/machinability than K273 and/or other lower chromium and nickel content alloys. The stainless steel alloys described herein include iron alloyed with various alloying elements, as are described in greater detail below in weight percentages based on the total weight of the alloy. Moreover, the discussion of the effects and inclusion of certain percentages of elements is particular to the exemplary alloy described herein.

In an embodiment, the austenitic stainless steel alloy of the present disclosure includes or consists of from about 23.0% to about 25.0% chromium (Cr), for example about 23.5% to about 24.5% Cr, such as about 23.7% to about 24.3% Cr. Chromium is provided, for example, to achieve the desired austenite phase for oxidation/corrosion resistance in the alloy when operating at relatively high temperatures, such as up to about 1,020° C. As stated initially, however, it is desirable to minimize the Cr content in order to reduce costs. Moreover, when the content of Cr increases, the content of similarly expensive Ni should be also increased to maintain the volume fraction, resulting in further cost increases. Furthermore, if Cr is added excessively, coarse primary carbides of Cr are formed, resulting in extreme brittleness. As such, it has been found herein that a balance is achieved between sufficient austenite phase stability and prevention of delta ferrite phase formation (along with cost reduction) when Cr is provided within the above described ranges, for example from about 23.0% to about 25.0%.

In an embodiment, the austenitic stainless steel alloy of the present disclosure includes or consists of from about 8.5% to about 10.0% nickel (Ni), for example about 8.8% to about 9.7% Ni, such as about 9.0% to about 9.5% Ni. Ni, together with manganese and nitrogen (which as described in greater detail below are included in the alloy of the present disclosure), is an element to stabilize the austenite phase, which as noted above is desirable to achieve the oxidation/corrosion resistance at high temperatures, along with the aforementioned Cr. To reduce production costs, if the content of relatively-expensive Ni is lowered, the decrement of Ni can be replaced by increasing the content of manganese and nitrogen that form the austenite phase. However, it has been found that if the content of Ni is excessively lowered, manganese and nitrogen would be excessively needed such that the corrosion/oxidation resistance and the hot formability characteristics are deteriorated. As such, it has been found herein that a balance is achieved between sufficient austenite phase stability and casting considerations (along with cost reduction) when Ni is provided within the above described ranges, for example from about 8.5% to about 10.0%.

In an embodiment, the austenitic stainless steel alloy of the present disclosure includes or consists of from about 0.5% to about 2.0% manganese (Mn), for example about 0.8% to about 1.7% Mn, such as about 1.0% to about 1.5% Mn. As initially noted above, Mn is provided for the stability of the austenite phase. Moreover, Mn is effective along with Si (which as described in greater detail below is included in the alloy of the present disclosure) as a deoxidizer for the melt, and it has a benefit of improving the fluidity during the casting operation. However, when the content of Mn is excessive, Mn is combined with sulfur of the steel and forms excessive levels of manganese sulfide, thereby deteriorating the corrosion resistance and the hot formability. As such, it has been found herein that a balance is achieved between sufficient austenite phase stability, deoxidation properties, and casting considerations when Mn is provided within the above described ranges, for example from about 0.5% to about 2.0%.

In an embodiment, the austenitic stainless steel alloy of the present disclosure includes or consists of from about 0.8% to about 1.0% niobium (Nb), for example about 0.85% to about 0.95% Nb, such as about 0.88% to about 0.92% Nb. The stainless steel of the present disclosure is provided with a high castability by forming eutectic carbides of Nb as well as a high strength and ductility.

In an embodiment, the austenitic stainless steel alloy of the present disclosure includes or consists of from about 0.5% to about 1.5% silicon (Si), for example about 0.8% to about 1.2% Si. Si has effects of increasing the stability of its metal structure and its oxidation resistance. Further, it has a function as a deoxidizer and also is effective for improving castability and reducing pin holes in the resulting cast products. If the content of Si is excessive, Si deteriorates mechanical properties of the alloy such as impact toughness of steel. As such, it has been found herein that a balance is achieved between sufficient mechanical properties, deoxidation properties, and casting considerations when Si is provided within the above described ranges, for example from about 0.5% to about 1.5%.

In an embodiment, the austenitic stainless steel alloy of the present disclosure includes or consists of from about 0.35% to about 0.45% carbon (C), for example about 0.37% to about 0.43% C. C generally provides hardness and strength to stainless steel and can form carbides with the metallic elements. Furthermore, C has a function of improving the fluidity and castability of a melt. When provided excessively, however, C can make stainless steel brittle, rendering it more likely to crack during use in turbocharger applications. As such, it has been found herein that a balance is achieved between sufficient mechanical properties and casting considerations when C is provided within the above described ranges, for example about 0.35% to about 0.45%.

In an embodiment, the austenitic stainless steel alloy of the present disclosure includes or consists of from about 0.2% to about 0.28% nitrogen (N), for example from about 0.22% to about 0.26% N. N, together with Ni, is one of elements that contribute stabilization of an austenite phase. As the content of N increases, the corrosion/oxidation resistance and high strengthening are achieved. However, when the content of N is too high, the hot formability of steel is deteriorated, thereby lowering the production yield thereof. Moreover, N is an element capable of improving the high-temperature strength and the thermal fatigue resistance like C. However, when N content is excessive, brittleness due to the precipitation of Cr nitrides may be encountered. As such, it has been found herein that a balance is achieved between austenite phase stability and corrosion/oxidation resistance, sufficient mechanical properties, and casting considerations when N is provided within the above described ranges, for example about 0.2% to about 0.28%.

Certain unavoidable/inevitable impurities may also be present in the austenitic stainless steel alloy of the present disclosure. The amounts of such impurities are minimized as much as practical. In an embodiment, phosphorus (P) may be present in the alloy, but is minimized to about 0.04% or less, such as to about 0.03% or less, for example to about 0.02% or less. P is seeded in the grain boundary or an interface, and it is likely to deteriorate the corrosion resistance and toughness. Therefore, the content of P is lowered as much as possible.

In an embodiment, certain relatively-expensive carbide forming elements may be excluded beyond impurity levels. These include, for example, tungsten and molybdenum, and any combination of two or more thereof may be excluded. It has been discovered that austenite phase stability, delta ferrite phase minimization, and sufficient mechanical and casting properties can be achieved without including these elements beyond levels that cannot be avoided as impurities, such as less than about 0.3%, less than about 0.1%, or less than about 0.05%. Further specific elements that may be excluded from the alloy (in greater than impurity amounts) include one or more of zirconium, sulfur, aluminum, titanium, vanadium, cobalt, and/or copper, and any combination of two or more thereof may be excluded beyond levels that cannot be avoided as impurities, such as less than about 0.3%, less than about 0.1%, or less than about 0.05%, which percentage is dependent on the particular element under consideration. In some embodiments, sulfur is excluded from the alloy beyond impurity levels, such as, if present, in an amount of about 0.04% or less, such as about 0.02% or less, for example about 0.01% or less. S in steels deteriorates hot workability and can form sulfide inclusions (such as MnS) that influence pitting corrosion resistance negatively. Therefore, the content of S is lowered as much as possible. In some embodiments, zirconium is excluded from the alloy beyond impurity levels, such as, if present, in an amount of about 0.02% or less, such as about 0.01% or less, such as about 0.005% or less, for example, about 0.002 or less.

Iron makes up the balance of the alloy as described herein. The disclosed alloy may comprise the foregoing elements, in that other elements may be included in the alloy composition within the scope of the present disclosure. Preferably, however, the disclosed alloy consists of the foregoing elements, in that other elements beyond those described above are not included in the alloy (in greater than inevitable/unavoidable impurity amounts).

TABLE 2 sets forth the compositional ranges of an exemplary austenitic stainless steel alloy the present disclosure, in accordance with an embodiment of the description provided above (all elements in wt. %).

TABLE 2
Composition of an Exemplary Stainless Steel Alloy.

| Elements | Min (wt. %) | Max (wt. %) |
|---|---|---|
| Chromium | 23.0 | 25.0 |
| Nickel | 8.5 | 10.0 |
| Manganese | 0.5 | 2.0 |
| Niobium | 0.8 | 1.0 |
| Silicon | 0.5 | 1.5 |
| Carbon | 0.35 | 0.45 |
| Nitrogen | 0.2 | 0.28 |
| Sulphur | 0 | 0.04 |
| Zirconium | 0 | 0.02 |
| Phosphorus | 0 | 0.04 |

| | |
|---|---|
| Iron/Impurities | Balance |

### Illustrative Examples

The present disclosure is now illustrated by the following non-limiting examples. It should be noted that various changes and modifications can be applied to the following examples and processes, without departing from the scope of this disclosure, which is defined in the appended claims. Therefore, it should be noted that the following examples should be interpreted as illustrative only and not limiting in any sense.

Using the materials simulation software Thermo-Calc® (available from Thermo-Calc Software AB; Stockholm, Sweden), various alloy compositions were evaluated to determine the stability of austenite phase for each of the combinations. In addition to achieving the austenite phase stability, the composition limits were also defined based on the amount of delta phase at high temperature, which reduces the nitrogen solubility. Further, the alloying elements were considered to maximize the nitrogen solubility, which eliminates nitrogen bubble formation during solidification during the casting process. A sensitivity analysis was conducted using Thermo-Calc®, which showed that chromium (Cr) and silicon (Si) can have a significant effect on nitrogen solubility, without an impact on the cost of the alloy.

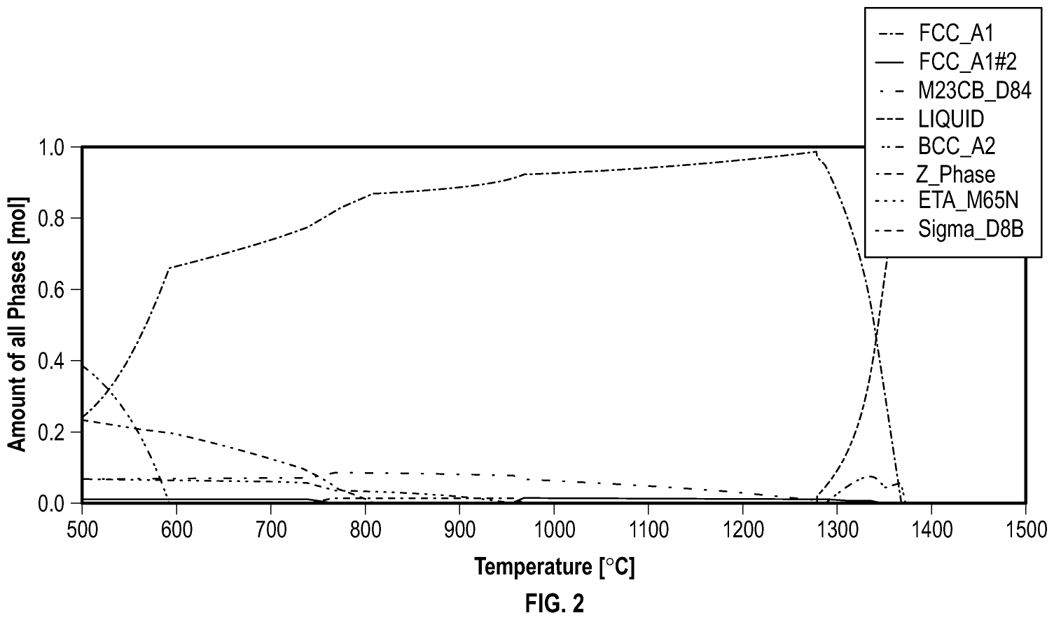

Referring to FIG. 2, a simulated phase diagram of an alloy in accordance with the present disclosure (Table 2) showing the phase constituencies (including austenite and delta ferrite) of the alloy over a temperature from 500° C. to 1,500° C. is provided. As illustrated, the delta phase is relatively very low, and the stability of the austenite phase is relatively very high for the exemplary alloy over a relatively broad temperature range that includes temperatures beyond 1,020° C.

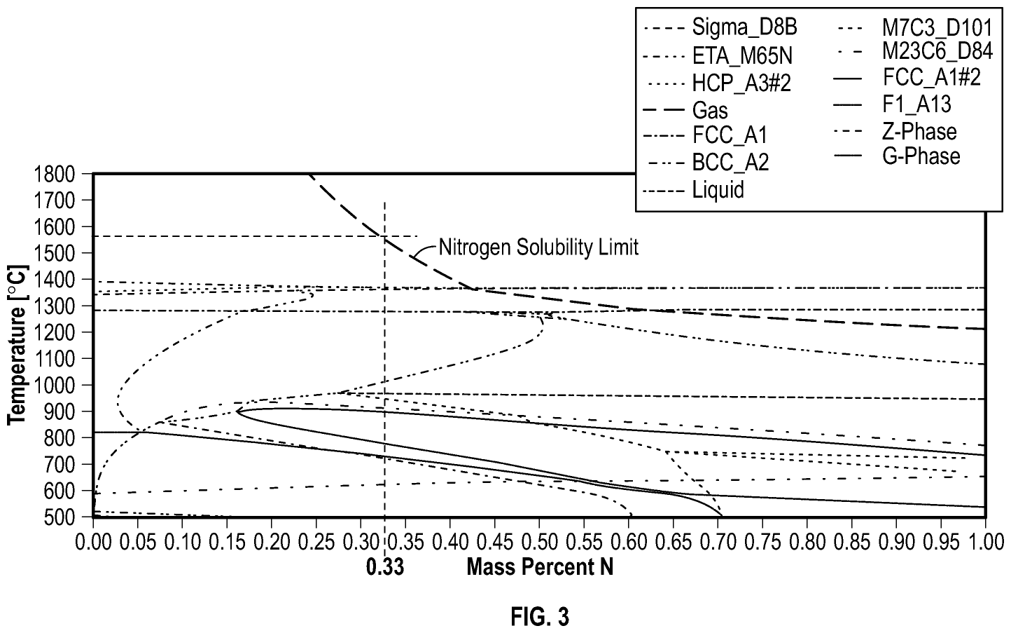

Referring to FIG. 3, a simulated diagram of nitrogen solubility limits as a function of temperature of an alloy in accordance with the present disclosure (Table 2) is provided. The nitrogen solubility limits were determined using the Thermo-Calc® simulation. Additionally, an experiment was conducted during a casting trial at a commercial foundry, in which nitrogen (N) was added more than its solubility limit and held at 1,550° C. for 1 hour. After 1 hour, the excess nitrogen was expelled from the liquid and the equilibrium content of 0.33 wt. % of N was achieved. Further, the calculation of equilibrium nitrogen concentration for this composition at 1,550° C. is shown in FIG. 2, which matched exactly with measured value. Notably, if the nitrogen in the alloy is lower than the solubility limit, nitrogen porosity does not form during solidification in the casting process.

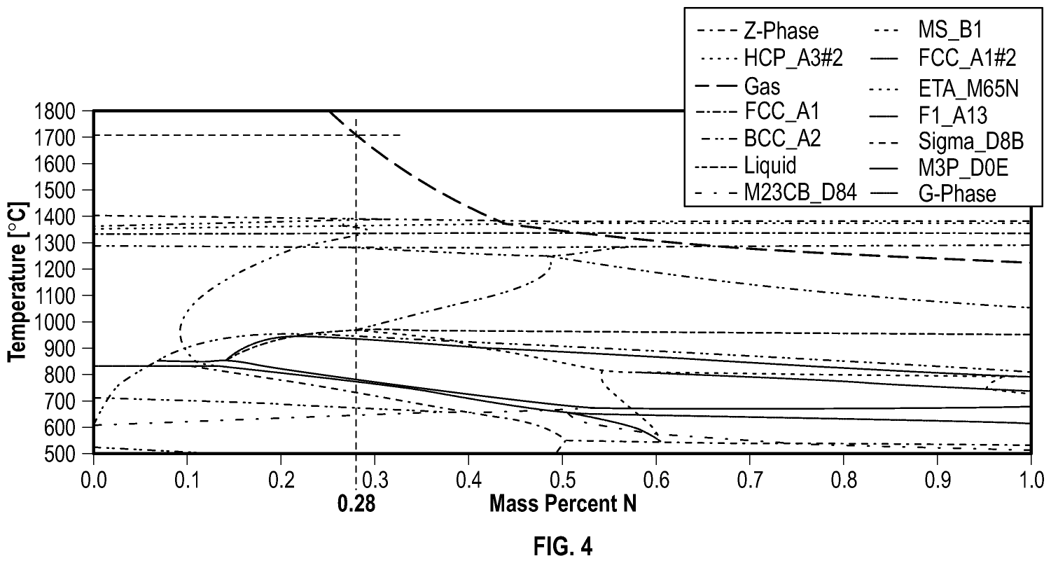

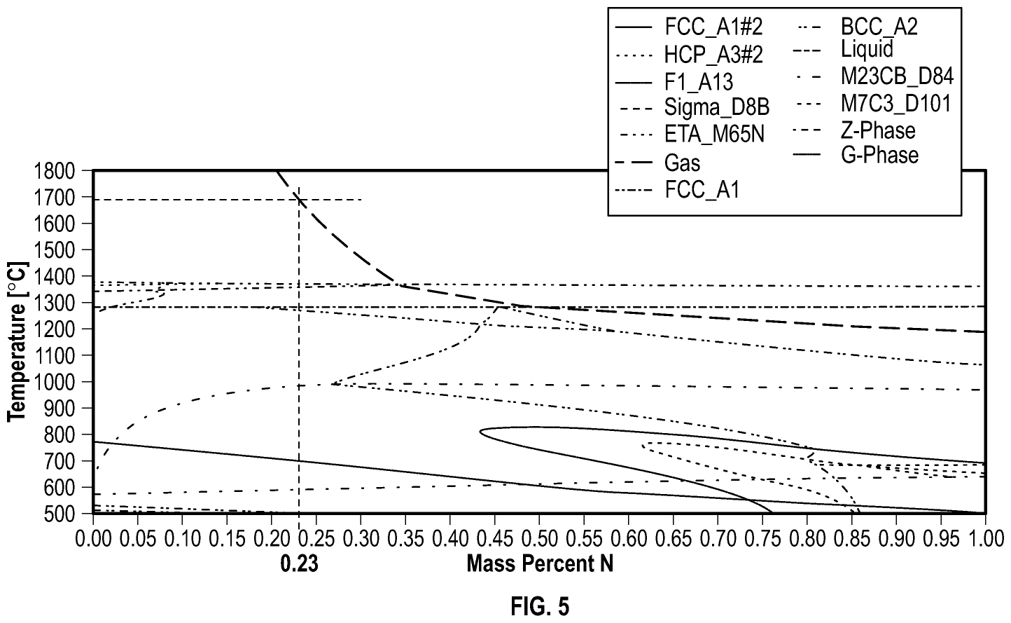

FIG. 4 is a simulated diagram of nitrogen solubility limits as a function of temperature of an alloy in accordance with the composition presented above in Table 2 in which the amounts of Cr and Si were altered to achieve increased equilibrium nitrogen solubility. FIG. 5 is a simulated diagram of nitrogen solubility limits as a function of temperature of an alloy having a composition presented below in Table 3 for comparison to the alloy presented in FIG. 4.

TABLE 3
Composition of a Comparison Stainless Steel Alloy.

| Elements | Min (wt. %) | Max (wt. %) |
|---|---|---|
| Chromium | 20.0 | 21.5 |
| Nickel | 8.5 | 10.0 |
| Manganese | 4.0 | 5.0 |
| Niobium | 0.5 | 1.5 |
| Silicon | 0.5 | 2.0 |
| Carbon | 0.4 | 0.5 |
| Nitrogen | 0.2 | 0.3 |
| Sulphur | 0 | 0.03 |
| Phosphorus | 0 | 0.03 |

| | |
|---|---|
| Iron/Impurities | Balance |

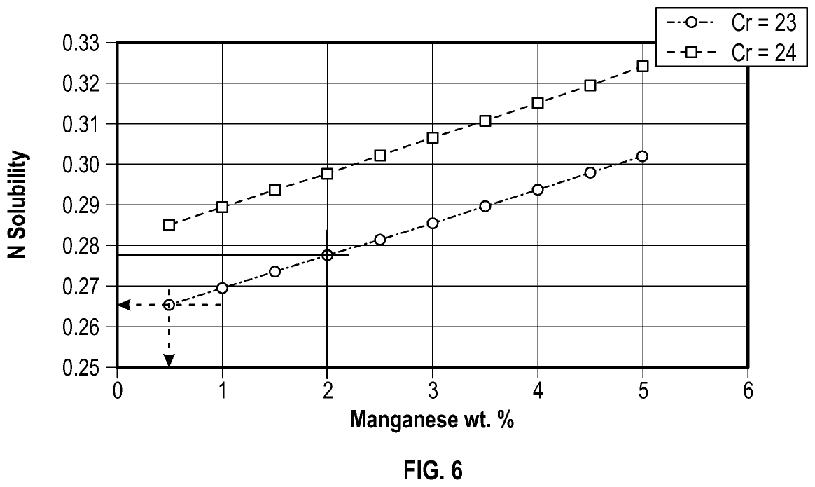

Referring to FIGS. 4-5, in addition to changes in Cr and Si, manganese (Mn) is lowered from 4.0-5.0 wt. % to 0.5 to 2.0 wt. % for the exemplary alloy of the present disclosure, wherein the lower range of Mn improves the castability characteristics and further improves the oxidation resistance of the alloy. Mn is often added to steel alloys for increasing the solubility of nitrogen, which increases proportionally to increases in Mn. However, using the Thermo-Calc® simulation, the equilibrium nitrogen content of the alloy illustrated in FIG. 4 of 0.28 wt. % is higher than what was achieved in of the alloy illustrated in FIG. 5 of 0.23 wt. %. Due to the lower solubility limit of nitrogen of the alloy presented in FIG. 5 (Table 3), nitrogen porosity is expected during solidification of the alloy in a casting process. Further, the exemplary alloy presented in FIG. 4 (Table 2) was surprisingly found to increase the nitrogen solubility to reduce or eliminate porosity issues caused from outgassing of nitrogen during the casting process, which can include tapping temperatures up to as high as about 1,650° C. to about 1,700° C., and additionally to provide oxidation resistance for the alloy up to operating temperatures to about 1,020° C. As shown in FIG. 6, a nitrogen solubility of 0.28% is achieved with 2.0% Mn.

As such, embodiments of the present disclosure provide numerous benefits over the prior art, including the minimization of expensive nickel content, minimization or elimination of porosity formed during a casting process, while maintaining desirable material properties for use as turbocharger turbine components, such as housing components or exhaust components. Moreover, the disclosed alloys maintain a stable austenite material phase above the intended temperature of operation, such as 1,020° C., while substantially minimizing the corrosion/oxidation-prone delta ferrite material phase. Thus, embodiments of the present disclosure are suitable for use as a lower cost alloy for turbocharger turbine components, such as turbocharger turbine housing, for design operations of up to about 1,020° ° C.

While the best modes for carrying out the disclosure have been described in detail, those familiar with the art to which this disclosure relates will recognize various alternative designs and embodiments for practicing the disclosure within the scope of the appended claims.

What is claimed is:

1. An austenitic stainless steel alloy, comprising, by weight:
about 23.0% to about 25.0% chromium;
about 8.5% to about 10.0% nickel;
about 0.5% to about 2.0% manganese;
about 0.8% to about 1.0% niobium;
about 0.5% to about 1.5% silicon;
about 0.35% to about 0.45% carbon;
about 0.2% to about 0.28% nitrogen; and
a balance of iron, and other inevitable/unavoidable impurities that are present in trace amounts, wherein zirconium and sulfur are excluded from the alloy beyond impurity levels.

2. The austenitic stainless steel alloy of claim 1 comprising about 23.5% to about 24.5% chromium.

3. The austenitic stainless steel alloy of claim 1 comprising about 8.8% to about 9.7% nickel.

4. The austenitic stainless steel alloy of claim 1 comprising about 0.8% to about 1.7% manganese.

5. The austenitic stainless steel alloy of claim 1 comprising about 0.8% to about 1.2% silicon.

6. The austenitic stainless steel alloy of claim 1 comprising about 0.37% to about 0.43% carbon.

7. The austenitic stainless steel alloy of claim 1 comprising about 0.22% to about 0.26% nitrogen.

8. The austenitic stainless steel alloy of claim 1, wherein if present, by weight, zirconium is about 0.02% or less and sulfur is about 0.04% or less.

9. The austenitic stainless steel alloy of claim 1, consisting of, by weight:
about 23.0% to about 25.0% chromium;
about 8.5% to about 10.0% nickel;
about 0.5% to about 2.0% manganese;
about 0.8% to about 1.0% niobium;
about 0.5% to about 1.5% silicon;
about 0.35% to about 0.45% carbon;
about 0.2% to about 0.28% nitrogen; and
a balance of iron, and other inevitable/unavoidable impurities that are present in trace amounts, wherein zirconium and sulfur are excluded from the alloy beyond impurity levels.

10. A turbocharger turbine component comprising:
an austenitic stainless steel alloy, wherein the austenitic stainless steel alloy comprises, by weight:
about 23.0% to about 25.0% chromium;
about 8.5% to about 10.0% nickel;
about 0.5% to about 2.0% manganese;
about 0.8% to about 1.0% niobium;
about 0.5% to about 1.5% silicon;
about 0.35% to about 0.45% carbon;
about 0.2% to about 0.28% nitrogen; and
a balance of iron, and other inevitable/unavoidable impurities that are present in trace amounts, wherein zirconium and sulfur are excluded from the alloy beyond impurity levels.

11. The turbocharger turbine component of claim 10, wherein the austenitic stainless steel comprises about 23.5% to about 24.5% chromium.

12. The turbocharger turbine component of claim 10, wherein the austenitic stainless steel alloy comprises about 8.8% to about 9.7% nickel.

13. The turbocharger turbine component of claim 10, wherein the austenitic stainless steel alloy comprises about 0.8% to about 1.7% manganese.

14. The turbocharger turbine component of claim 10, wherein the austenitic stainless steel alloy comprises about 0.8% to about 1.2% silicon.

15. The turbocharger turbine component of claim 10, wherein the austenitic stainless steel alloy comprises about 0.37% to about 0.43% carbon.

16. The turbocharger turbine component of claim 10, wherein the austenitic stainless steel alloy comprises about 0.22% to about 0.26% nitrogen.

17. The turbocharger turbine component of claim 10, wherein the austenitic stainless steel alloy consists of, by weight:
about 23.0% to about 25.0% chromium;
about 8.5% to about 10.0% nickel;
about 0.5% to about 2.0% manganese;
about 0.8% to about 1.0% niobium;
about 0.5% to about 1.5% silicon;
about 0.35% to about 0.45% carbon;
about 0.2% to about 0.28% nitrogen; and
a balance of iron, and other inevitable/unavoidable impurities that are present in trace amounts, wherein zirconium and sulfur are excluded from the alloy beyond impurity levels.

18. The turbocharger turbine component of claim 10, wherein the turbocharger turbine component comprises a turbocharger turbine housing.

19. A vehicle comprising the turbocharger turbine component of claim 10.

20. A method of making a turbocharger turbine component comprising forming the turbocharger turbine component using an austenitic stainless steel alloy, wherein the austenitic stainless steel alloy comprises, by weight:
about 23.0% to about 25.0% chromium;
about 8.5% to about 10.0% nickel;
about 0.5% to about 2.0% manganese;
about 0.8% to about 1.0% niobium;
about 0.5% to about 1.5% silicon;
about 0.35% to about 0.45% carbon;
about 0.2% to about 0.28% nitrogen; and
a balance of iron, and other inevitable/unavoidable impurities that are present in trace amounts, wherein zirconium and sulfur are excluded from the alloy beyond impurity levels.
